(19) United States
(12) Patent Application Publication
(10) Pub. No.: US 2003/0174045 A1
(43) Pub. Date: Sep. 18, 2003

(54) Automatic garage door controlling apparatus and methods

(76) Inventor: Shiyu Zhang, Hayward, CA (US)

Correspondence Address: SHIYU ZHANG, 30190 BRIDGEVIEW WAY, HAYWARD, CA, 94544, US

(21) Appl. No.: 10/097,948

(22) Filed: Mar. 14, 2002

(51) Int. Cl. H04Q 1/00; G05B 19/00

(52) U.S. Cl. 340/5.64; 340/5.71

(57) ABSTRACT

An automatic garage door status signaling apparatus comprises a push button, a garage door opening and closing circuitry, a signal indicating circuitry, and a delay timer control circuitry is provided. An indicating signal is generated if the push button is not pressed within a predetermined time period after the delay timer control circuitry is activated. An automatic garage door status indicating apparatus comprises a push button, a garage door opening and closing circuitry and a garage door status indicating circuitry is also provided. In one embodiment, the garage door status indicating circuitry comprises a time log. In another embodiment, the garage door status indicating circuitry comprises a timer, which can be a clock.

### STATEMENT REGARDING FEDERALLY SPONSORED RESEARCH OR DEVELOPMENT

Not Applicable

### CROSS-REFERENCE TO RELATED APPLICATIONS

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates generally to automatic garage doors, and is more particularly directed to automatic garage door status signaling and indicating apparatus and methods.

2. Description of the Prior Art

Automatic garage door openers are used to open and close automatic garage doors. After a vehicle exits the garage, an automatic garage door opener resides inside the vehicle needs to be pressed to close the garage door. However since the driver may get distracted while exiting the garage, he might forget to close the garage door. In some cases, the driver may doubt whether he pressed the garage door opener to close the garage door or not; he may have to go back to the house to make sure that the garage door is closed. U.S. Pat. Nos. 4,954,810, 5,247,232, 5,883,579, 6,011,648, and 6,166,634 have suggested different solutions to this problem. However, each of these references requires complicated additional circuits to both garage door and openers. Modifications of the automatic garage door opener system are always required.

Accordingly, it is seen that there exists a need to provide apparatus and methods to signal the status of the garage door to the occupants of a vehicle. It is also seen that there exists a need to provide apparatus and methods to indicate the status of the garage door.

### BRIEF SUMMARY OF THE INVENTION

An automatic garage door controlling apparatus of present invention works with an automatic garage door opener to alert the driver of a vehicle to close the garage door after exiting the garage. The automatic garage door controlling apparatus comprises a vehicle power on means, a push button, a time delay control circuitry, and an alarm warning circuitry. After the driver of a vehicle turns on the power of the vehicle, the automatic garage door controlling apparatus sends out a signal to alert the driver of the vehicle to close the garage door if the time delay control signal expires before the driver presses an automatic garage door opener to close the garage door. Pressing the automatic garage door opener deactivates the automatic garage door controlling apparatus. An deactivator is also provided to deactivate the signal. The driver can also deactivate the garage door controlling apparatus before the indicating signal is activated.

This apparatus can be a retrofit add-on to an existing garage door opener, or it can be built in device in a garage door opener.

An automatic garage door status indicating apparatus of present invention works with an automatic garage door opener to provide the driver of a vehicle a measure whether the automatic garage door opener is pressed or not when he exits the garage.

In one embodiment of the automatic garage door status indicating apparatus, a time log comprising a clock and a memory is provided. When the automatic garage door opener is pressed, the time is stored in the time log to provide the driver a record of time the automatic garage door opener was pressed. From the reading of the time log, the driver can make a judgment whether he closed the garage door or not when he drove away from the garage. Similarly, this apparatus can be a retrofit add-on to an existing garage door opener, or it can be a built in device in a garage door opener.

In another embodiment of the automatic garage door status indicating apparatus, a timer, which can be simply a clock, is provided. The clock is reset to a predetermined value when the automatic garage door opener is pressed. From the reading of the clock, the driver can make a judgment whether he closed the automatic garage door or not when he drove away from the garage. This apparatus can be a retrofit add-on to an existing garage door opener, or it can be built in device in a garage door opener.

Accordingly, it is an object of the present invention to provide an automatic garage door controlling apparatus to alert the occupants of a vehicle to close the garage door.

It is a further object of the present invention to provide an automatic garage door status indicating apparatus to indicate whether the automatic garage door opener is pressed or not.

It is another object of the present invention to provide a time log to record the time when the automatic garage door opener was pressed.

It is yet another object of the present invention to provide a timer to indicate the time difference between the current time and the time when the automatic garage door opener was pressed.

Furthermore, it is an object of the present invention to provide an apparatus with a remotely disposed reset button to measure the time difference of two different moments, the reset button will reset the reading of the apparatus to a predetermined value.

It is also an object of present invention to provide an automatic garage door opener which comprises an automatic garage door status signaling circuitry.

It is yet an object of the present invention to provide an automatic garage door opener which comprises a garage door status indicating circuitry.

It is an advantage of the present invention to provide an external circuitry thereby no modification of current automatic garage door circuitry is needed.

It is another advantage of the present invention to provide a cheap and reliable means to alert the vehicle occupants to close the garage door.

It is yet another advantage of the present invention to provide a cheap and reliable means to indicate whether the automatic garage door opener has been pressed or not.

It is a feature of the present invention that the present automatic garage door controlling and indicating apparatuses and methods implement the principles of time related means.

These and other objects, advantages, and features will become readily apparent in view of the following detailed description.

### BRIEF DESCRIPTION OF THE SEVERAL VIEWS OF THE DRAWINGS

FIG. 1A is a flowchart showing the operation principle of an automatic garage door controlling device according to the present invention.

FIG. 1B is an operation block diagram showing the automatic garage door status signaling device following the operation principle shown in FIG. 1A according to a preferred embodiment of the present invention.

FIG. 1C is an operation block diagram showing the automatic garage door status signaling device following the operation principle shown in FIG. 1A according to another preferred embodiment of the present invention.

FIG. 2A is a flowchart showing the operation principle of an automatic garage door status indicating device according to the present invention.

FIG. 2B is an operation block diagram showing the automatic garage door status indicating device following the operation principle shown in FIG. 2A according to another preferred embodiment of the present invention.

FIG. 2C is an operation block diagram showing the automatic garage door status indicating device following the operation principle shown in FIG. 2A according to another preferred embodiment of the present invention.

FIG. 3A is a flowchart showing the operation principle of yet another automatic garage door status indicating device according to the present invention.

FIG. 3B is an operation block diagram showing the automatic garage door status indicating device following the operation principle shown in FIG. 3A according to another preferred embodiment of the present invention.

FIG. 3C is an operation block diagram showing the automatic garage door status indicating device following the operation principle shown in FIG. 3A according to another preferred embodiment of the present invention.

FIG. 4A is a schematic diagram of an embodiment showing an automatic garage door opener and an add-on push button.

FIG. 4B is a schematic diagram showing the add-on push button disposed on the top of the automatic garage door opener shown in FIG. 4A.

FIG. 4C is a schematic diagram showing the built-in push button of an automatic garage door opener acts as the push button.

FIG. 4D is a schematic diagram of another embodiment showing an automatic garage door opener and an add-on push button separately disposed.

FIG. 4E is a schematic diagram showing the add-on push button disposed on the top of the automatic garage door opener shown in FIG. 4D.

FIG. 4F is a schematic diagram showing the cross-section the un-pressed add-on push button and the automatic garage door opener as shown in FIG. 4D.

FIG. 4G is a schematic diagram showing the cross-section of the pressed add-on push button pressing the automatic garage door opener as shown in FIG. 4D.

### DETAILED DESCRIPTION OF THE INVENTION

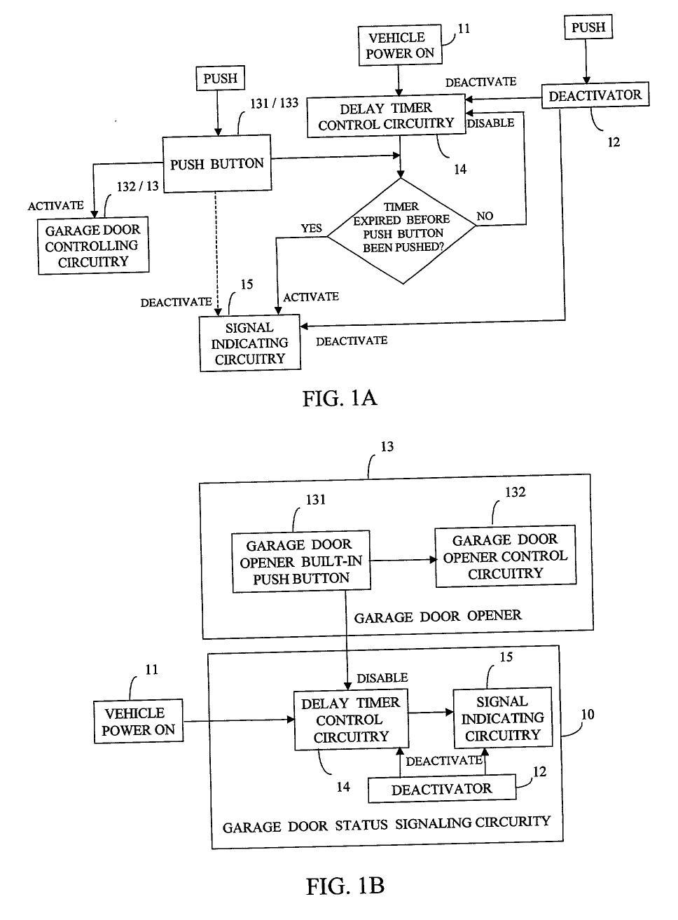

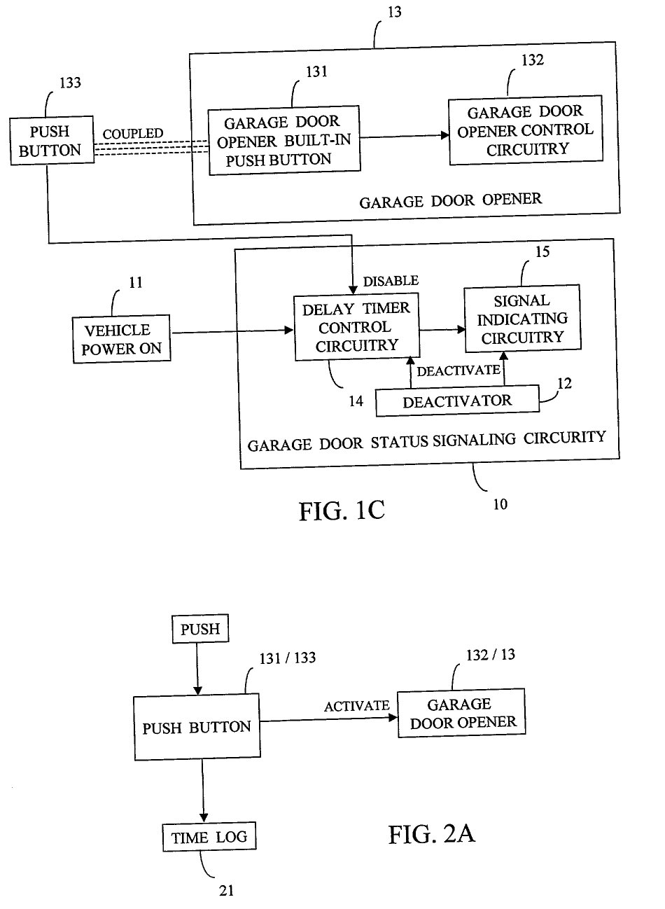

Two embodiments of an automatic garage door status signaling device of the present invention are illustrated in FIGS. 1A, 1B, and 1C.

As shown in FIGS. 1A, 1B, and 1C, an automatic garage door status signaling device comprises a vehicle power on means 11, an automatic garage door status signaling circuitry 10, and an automatic garage door opener 13. The garage door status signaling circuitry 10 comprises a signal deactivator 12, a delay timer control circuitry 14, and a signal indicating circuitry 15. The automatic garage door opener 13 comprises an automatic garage door opener built-in push button 131 and an automatic garage door opener control circuitry 132.

In FIG. 1B, the push button 131 is used to activate both the garage door opener circuitry 132 and the delay timer control circuitry 14. In FIG. 1C, an add-on push button 133 is utilized. The add-on push button 133 is coupled to the garage door built-in push button 131 so that pressing push button 131 will activate add-on push button 133 and pressing the add-on push button 133 will activate the built-in push button 131.

When the driver turns on the ignition, the vehicle power on means 11 actives the delay timer control circuitry 14, which generates a time delay signal of predetermined length in time.

If the push button 131 or 133 is pressed before the time delay signal expires, the delay timer control circuitry will disable the automatic garage door close alert device.

If the time delay signal expires before the push button 131 or 133 is pressed, the delay timer control circuitry will activate the signal indicating circuitry 15. The signal indicating circuitry 15 will send out an indicating signal such as sound, light, or mechanical signal to signal the driver to press the push button 131 or 133 to close the garage door. Pressing push button 131 or 133 will deactivate the signal indicating circuitry 15 to deactivate the signal.

Sometimes the driver need to leave the garage without closing the garage door. The deactivator 12 deactivates the delay timer circuitry 14, so the indicating signal is not activated. The deactivator 12 also deactivates the signal indicating circuitry 15 when the indicating signal is activated.

The vehicle power on means 11 can be any electrical circuitry that will be turned on when the vehicle electrical power is turn on. The vehicle power on means 11 can be simply an electrical adapter to be plugged in a vehicle cigarette lighter outlet, which will be powered on when electrical power of this vehicle is turned on. The vehicle power on means 11 can also be an indication of the movement of the vehicle, or any other action which can be used to trigger the time delay circuitry 14.

The described garage door status signaling circuitry can be implemented in an automatic garage door opener to provide a means to alert the occupants of a vehicle to close the garage door.

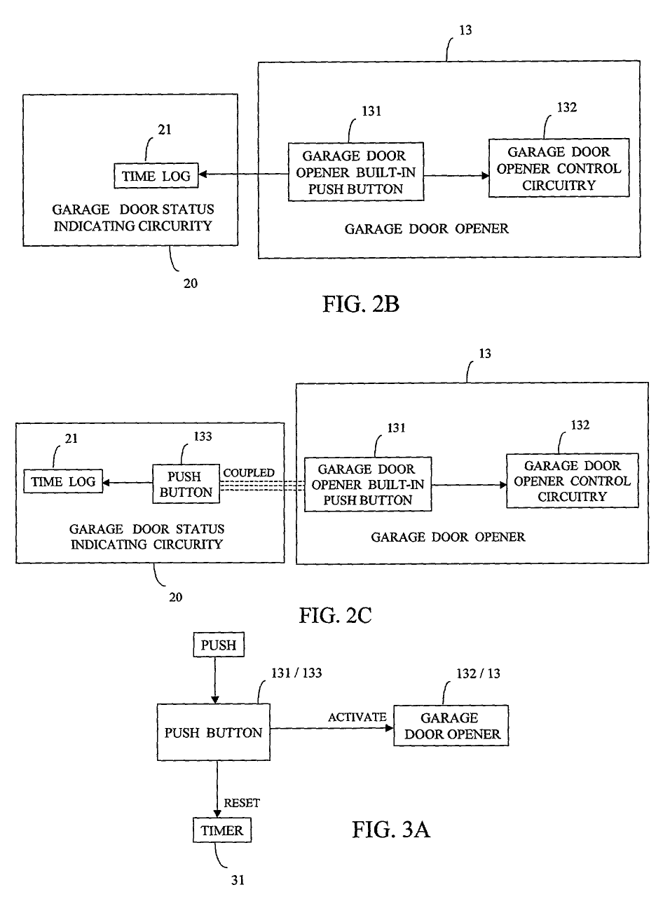

Two embodiments of an automatic garage door status indicating device of the present invention are illustrated in FIGS. 2A, 2B, and 2C.

As shown in FIGS. 2A, 2B, and 2C, an automatic garage door status indicating device comprises the automatic garage door opener 13, and a garage door close indicator 20. The automatic garage door opener 13 comprises the garage door built-in push button 131 and the garage door opener control circuitry 132.

In FIG. 2B, the automatic garage door close indicator 20 comprises a time log 21. The push button 131 is used to activate both the automatic garage door opener circuitry 132 and the time log 21. In FIG. 2C, the garage door close indicator 20 comprises a time log 21 and an add-on push button 133. Similar to FIGS. 1A, and 1C, the add-on push button 133 is coupled to the garage door built-in push button 131 in a means pressing push button 131 will activate push button 133 and pressing push button 133 will activate push button 131.

When the driver exits the garage, if the driver presses the push button 131 or 133 to close the garage door, the exact time the push button 131 or 133 is pressed is recorded in the time log 21. By checking the time log 21, the driver knows when was the last time the push button 131 or 133 was pressed. The driver can then decide whether to go back to the garage or not.

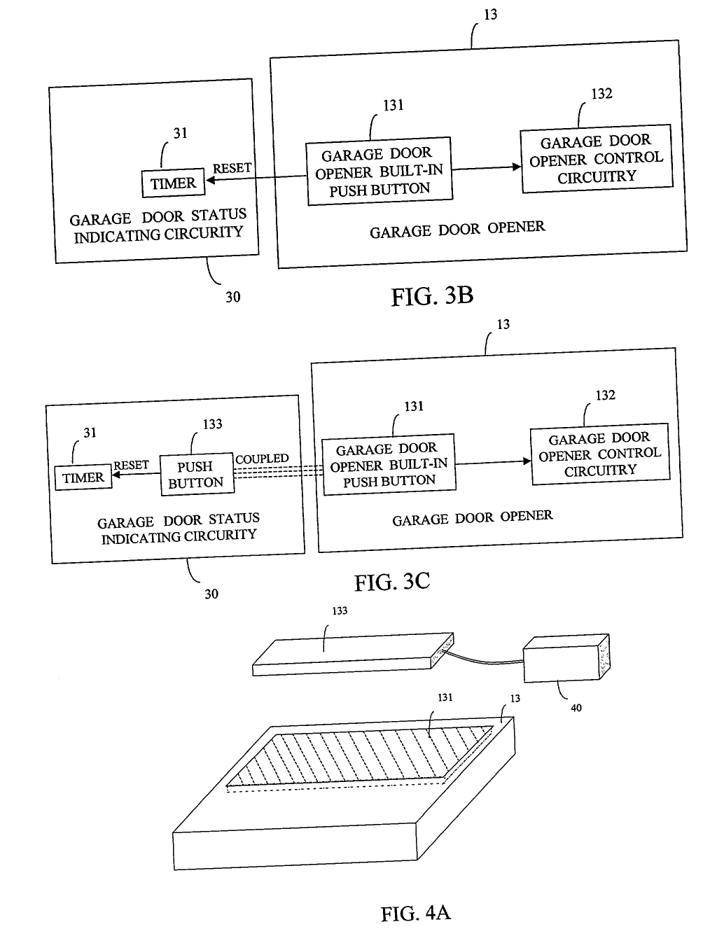

Another two embodiments of an automatic garage door status indicating device of the present invention are illustrated in FIGS. 3A, 3B, and 3C.

As shown in FIGS. 3A, 3B, and 3C, another automatic garage door status indicating device comprises the automatic garage door opener 13, and an automatic garage door close indicator 30. Similarly, the garage door opener 13 comprises the garage door built-in push button 131 and the garage door opener control circuitry 132.

In FIG. 3B, the garage door close indicator 30 comprises a timer 31. The push button 131 is used to activate both the garage door opener circuitry 132 and the timer 31. In FIG. 3C, the garage door close indicator 30 comprises a timer 31 and an add-on push button 133. Similar to FIGS. 1A, and 1C, the add-on push button 133 is coupled to the garage door built-in push button 131 in a means pressing push button 131 will activate push button 133 and pressing push button 133 will activate push button 131.

When the driver exits the garage, if the driver presses the push button 131 or 133 to close the garage door, the timer 31 is reset to a predetermined value. With time passes, the value on the timer will change accordingly. By checking the value of the timer 31, the driver knows when the push button 131 or 133 was pressed. The driver can then decide whether to go back to the garage or not.

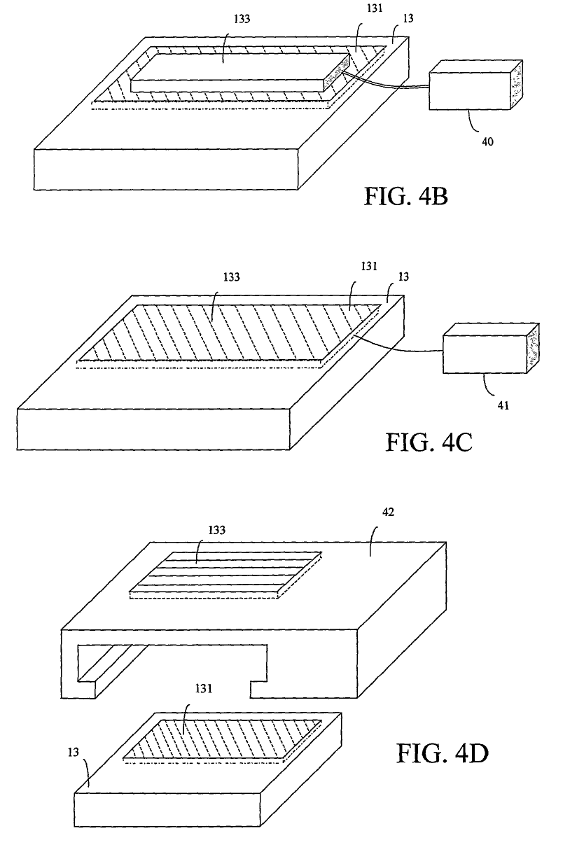

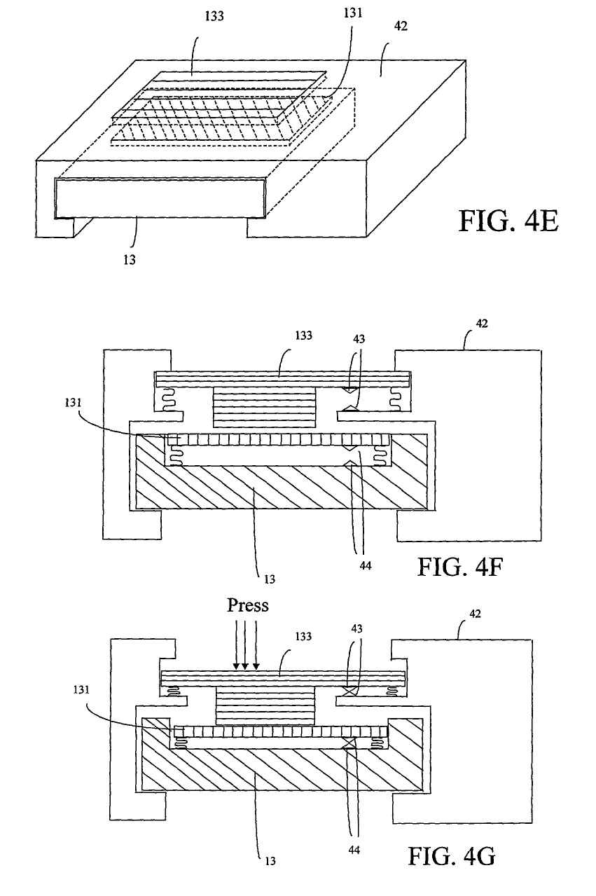

FIGS. 4A-4B, 4D-4G illustrate several exemplary coupling methods which can be used to couple the add-on push button 133 to garage door built-in push button 131.

FIG. 4A shows the automatic garage door opener 13, the garage door built-in push button 131, and the add-on push button 133. Here part 40 indicates the garage door status signaling circuitry 10 if shown in FIG. 1C, or the garage door status indicating alert circuitry 20 if shown in FIG. 2C, or the garage door status indicating alert circuitry 30 if shown in FIG. 3C.

FIG. 4B shows the add-on push button 131 of FIG. 4A disposed on the top of the built-in push button 131. So pressing the add-on push button 131 will activate the built-in push button 131.

FIG. 4C shows the built-in push button of the garage door opener acts as the push button as indicated in FIG. 1B, FIG. 2B, or FIG. 3B. Here part 41 represents the garage door status signaling circuitry 10 if shown in FIG. 1B, or the garage door status indicating alert circuitry 20 if shown in FIG. 2B, or the garage door status indicating alert circuitry 30 if shown in FIG. 3B.

FIG. 4D shows an automatic garage door opener 13, an add-on push button 133, and a part 42. Part 42 is basically the same as part 40 as shown in FIG. 4A or part 41 as shown in FIG. 4C.

FIG. 4E shows the automatic garage door opener 13 of FIG. 4D disposed under the add-on push-button 133.

The cross-section diagram of the un-pressed add-on push button and the automatic garage door opener of FIG. 4D is shown in FIG. 4F. Here contacts 43 is open, and contacts 44 is also open.

When the add-on push button 133 of FIG. 4F is pressed, the contacts 43 will be closed. Pressing the add-on push button 133 will activate the built-in push button 131 of the automatic garage door opener 13. So contacts 44 will be closed. As illustrated in FIG. 4G.

The above described garage door status indicating circuitry can be implemented in a garage door opener to provide a means to provide the occupants of a vehicle an indication when the garage door is closed or not.

All above apparatus can be retrofit add-ons to an existing garage door opener, or they can be a built in device in a garage door opener.

In accordance with the garage door controlling and indicating devices of the present invention, the following unexpected resulting advantages can be achieved.

It will thus be seen that the present invention does indeed provide new and improved devices for the garage door controlling and indicating system, which is simple and requires minimum modification to the current garage door system.

Although specific embodiments have been illustrated and described, it will be obvious to those skilled in the art that various modifications may be made without departing from the spirit and scope of the invention. The described embodiments are to be considered in all respects only as illustrative and not restrictive. The scope of the present invention is, therefore, indicated by the appended claims rather than by the foregoing description. All changes that come within the meaning and range of equivalency of the claims are to be embraced within their scope.

I claim:

1. An automatic garage door controlling apparatus for opening and closing an automatic garage door, which is to be used in a vehicle, comprising:
an automatic garage door controlling circuitry, which opens and closes said garage door when activated;
a push button, which is to be pushed to activate said controlling circuitry to open and close said garage door; and
time varying means for monitoring time changes, which changes a value with time passing by.

2. The controlling apparatus of claim 1 wherein said time varying means is a time log;
wherein said time log comprising:
a clock, which indicates the moment said push button is pushed; and
a memory, which records the time indicated by said clock when said push button is pushed.

3. The controlling apparatus of claim 1 wherein said time varying means is a timer;
wherein said timer works in a running mode which a displayable value changes with time passing by; and
wherein said timer comprising reset means for setting said timer to a predetermined value, and for setting said timer to operate in said running mode.

4. The controlling apparatus of claim 3 wherein said reset means of said timer is remotely disposed from said timer.

5. The controlling apparatus of claim 1 wherein said time varying means is a delay timer control circuitry;
wherein said controlling apparatus further comprises signal indicating means for generating an indicating signal to signal the occupants of said vehicle to close the garage door;
wherein said delay timer control circuitry generates a time delayed signal of a predetermined length in time when activated by an activation signal; and
wherein said delay timer control circuitry actives said signal indicating means if said time delayed signal of said predetermined length in time expires before said push button is pushed to close said garage door.

6. The controlling apparatus of claim 1 wherein said push button is a built-in push button of a garage door opener for opening and closing said garage door.

7. The controlling apparatus of claim 1 wherein said push button is an add-on push button;
wherein said add-on push button is coupled to a built-in push button of a garage door opener for opening and closing said garage door;
whereby pressing said add-on push button activates said built-in push button of said garage door opener.

8. The controlling apparatus of claim 1 wherein said push button is an add-on push button;
wherein said add-on push button is coupled to a built-in push button of a garage door opener for opening and closing said garage door;
whereby pressing said built-in push button of said garage door opener activates said add-on push button.

9. The controlling apparatus of claim 5 further comprises a deactivator;
wherein said deactivator deactivates said signal indicating means.

10. The controlling apparatus of claim 5 further comprises deactivating means for deactivating said controlling apparatus.

11. The controlling apparatus of claim 5 wherein said predetermined time ranges approximately from two seconds to twenty minutes.

12. The controlling apparatus of claim 5 wherein said activation signal is activated when the vehicle ignition is turned on.

13. The controlling apparatus of claim 5 wherein said activation signal is connected with an adapter in a vehicle cigarette lighter outlet of said vehicle, said activation signal is activated when the ignition of said vehicle is turned on.

14. A method for indicating the status of a garage door, said method to be used in a vehicle, said method comprising:
activating a time delayed signal; and
generating a signal to activate signal indicating means for signaling the occupants of said vehicle to close the garage if said time delayed signal expires before the occupant of said vehicle pressing a push button to close said garage door.

15. The method of claim 14 further comprising:
attaching said push button to a push button of a garage door opener for said garage door.

16. The method of claim 14 further comprising:
deactivating said signal indicating means by pressing a deactivator.

17. The method of claim 14 further comprising:
deactivating said signal indicating means by pressing said push button.

18. A method for indicating the status of a garage door, said method to be used in a vehicle, said method comprising:
resetting the value of a timer to a predetermined value by pressing a push button of a garage door opener for said garage door; and
keeping said timer in a running mode which changes a value with time.

19. A method for indicating the status of a garage door, said method to be used in a vehicle, said method comprising:
pressing a push button of a garage door opener to close said garage door at a time;
recording the time from the reading of a clock; and
storing said time in a memory.

20. The method of claim 19 further comprising:
displaying the content of said memory to the occupants of said vehicle.
